(19) United States
(12) Patent Application Publication
(10) Pub. No.: US 2021/0331387 A1
(43) Pub. Date: Oct. 28, 2021

(54) ADDITIVE MANUFACTURE OF BARRIER SLEEVE INSERTS FOR SINTERED BITS

(71) Applicant: Baker Hughes Oilfield Operations LLC, Houston, TX (US)

(72) Inventors: Stephen Duffy, Spring, TX (US); Brian Steven Wieneke, Spring, TX (US); Juan Miguel Bilen, The Woodlands, TX (US)

(21) Appl. No.: 16/861,095

(22) Filed: Apr. 28, 2020

(51) Int. Cl. B29C 64/171; E21B 10/633; E21B 10/34; E21B 10/43; B29C 64/153

(52) U.S. Cl. CPC B29C 64/171; E21B 10/633; B29C 64/153; E21B 10/43; E21B 10/34

(57) ABSTRACT

A method of manufacturing an earth boring tool body including the following steps: providing a mold, the mold comprising a mold cavity defining an interior surface corresponding to an exterior shape of a tool body and a plurality of blades. Forming at least one barrier sleeve insert and disposing it adjacent the interior surface defining the mold cavity; disposing a first powder in the gap between the insert and the interior surface, disposing a second powder in the mold cavity; disposing an infiltrant material adjacent the powders; and heating the mold, thereby infiltrating the infiltrant material into the powders to form the tool body. The disclosure also includes a mold for manufacturing an earth boring tool, the mold comprising a mold cavity defining interior surfaces corresponding to an exterior shape of the tool body and the plurality of blades. Barrier sleeve inserts and/or containment sleeve inserts may be disposed adjacent interior surfaces the mold cavity.

### FIELD

Embodiments of the present disclosure relate generally to methods of manufacturing matrix body earth boring tools in which barrier sleeve inserts are placed within a mold. The barrier sleeve inserts are configured to assist in placing and retaining powder materials in precise locations in the mold.

### BACKGROUND

Wellbores are formed in subterranean formations for various purposes including, for example, extraction of oil and gas from the subterranean formation, and extraction of geothermal heat from the subterranean formation. Wellbores may be formed in a subterranean formation using earth-boring tools, such as an earth-boring rotary drill bit. The earth-boring rotary drill bit is rotated and advanced into the subterranean formation. As the earth-boring rotary drill bit rotates, the cutting elements or abrasive structures thereof cut, crush, shear, and/or abrade away the formation material to form the wellbore. A diameter of the wellbore drilled by the drill bit may be defined by the cutting structures disposed at the largest outer diameter of the drill bit.

The earth-boring rotary drill bit is coupled, either directly or indirectly, to an end of what is referred to in the art as a “drill string,” which comprises a series of elongated tubular segments connected end-to-end that extends into the wellbore from the surface of earth above the subterranean formations being drilled. Various tools and components, including the drill bit, may be coupled together at a distal end of the drill string at the bottom of a wellbore being drilled. This assembly of tools and components is referred to in the art as a “bottom-hole assembly” (BHA).

The earth-boring rotary drill bit may be rotated within the wellbore by rotating the drill string from the surface of the formation, or the drill bit may be rotated by coupling the drill bit to a downhole motor, which is coupled to the drill string and disposed proximate to the bottom of the wellbore. The downhole motor may include, for example, a hydraulic Moineau-type motor having a shaft, to which the earth-boring rotary drill bit is mounted, that may be caused to rotate by pumping fluid (e.g., drilling mud or fluid) from the surface of the formation down through the center of the drill string, through the hydraulic motor, out from nozzles in the drill bit, and back up to the surface of the formation through the annular space between the outer surface of the drill string and the exposed surface of the formation within the wellbore. The downhole motor may be operated with or without drill string rotation.

Different types of earth-boring rotary drill bits are known in the art, including fixed-cutter drill bits, rolling-cutter drill bits, and hybrid drill bits (which may include, for example, both fixed cutters and rolling cutters). Fixed-cutter drill bits have bit bodies that include various features such as a core, blades, nozzle inserts, and cutting element pockets that extend into the bit body. The blades typically support Polycrystalline Diamond Compact (PDC) cutting elements which, in turn, perform the cutting operation. Typically, the PDC cutting elements are fabricated separately from the bit body and secured within cutting element pockets formed in an outer surface of the blade. A bonding material such as an adhesive or, more typically, a braze alloy may be used to secure the cutting elements within the pockets. The fixed-cutter drill bit may be placed in a bore hole such that the cutting elements are adjacent to the earth formation to be drilled. As the drill bit is rotated, the cutting elements scrape across and shear away the surface of the underlying formation.

FIG. 1 illustrates a fixed-cutter earth-boring rotary drill bit 100. The drill bit 100 includes a bit body 102 that may further include a plurality of blades 104 that are separated by junk slots 106. The bit body 102 may include internal fluid passageways that extend between the plurality of blades 104 of the bit body 102 and a longitudinal bore, extending through the shank to a drill string. The bit body 102 may further include nozzles 108 in the junk slots 106 that are connected to the internal fluid passageways. In some embodiments, the bit body 102 may include gage wear plugs 110 and wear knots 112. A plurality of cutting elements 114 may be mounted on the plurality of blades 104 of the bit body 102 in cutting element pockets 116 that are located along an outer surface of each of the plurality of blades 104. Typically, the cutting elements 114 are fabricated separately from the bit body 102 and are secured within cutting element pockets 116 formed in an outer, or exterior, of each of the plurality of blades 104 of the bit body 102. The cutting elements 114 are generally bonded to each of the plurality of blades 104 of the bit body 102 by methods such as brazing, adhesive bonding, or mechanical affixation. Furthermore, if the cutting elements 114 are polycrystalline diamond (PDC) cutting elements, the cutting elements 114 may include a polycrystalline diamond compact table secured to a substrate, which may be unitary or comprise two components bonded together.

Drill bit 100 may be used to perform drilling operations during which the surfaces of the bit body 102, the plurality of blades 104, and the cutting elements 114 may be subjected to extreme forces and stresses as the cutting elements 114 shear away the underlying earth formation. These extreme stresses and forces will abrade, erode, and wear down the cutting elements 114, the plurality of blades 104, and the surfaces of the bit body 102. Ideally, the materials of rotary drill bit 100 must be extremely hard to withstand abrasion and erosion attendant to drilling earth formations without excessive wear.

There are generally two types of fixed-cutter bits; steel bodied bits and matrix bodied bits. Steel bodied bits are usually preferred for soft and nonabrasive formations and large hole size. Steel bodied bits are also better able to withstand higher shear, impact, and load stresses than matrix bodied bits. Matrix bits are typically formed from a particle-matrix composite material. Matrix bits are usually manufactured with tungsten carbide, which is more erosion-resistant than steel. Matrix bits are usually preferred when using high Solid-content drilling mud. The particle-matrix composite material of a matrix bit includes hard particles randomly dispersed throughout a metallic binder material.

In steel drill bits, it has been found to be desirable to have the cutting face and other surfaces of the steel bit body comprise very hard materials while the interior of the steel bit body comprises a softer material that exhibits high strength and high fracture toughness. One way to accomplish this objective is to apply composite materials to surfaces of the bit body that are subjected to extreme wear. These composite or hard particle materials are often referred to as “hardfacing” materials. Hardfacing materials typically exhibit relatively high erosion resistance and high hardness while the interior of the steel bit body exhibits relatively high strength and high fracture toughness. However, erosion of the steel bit body around the cutting elements may still occur even when erosion-resistant hardfacing is applied to surfaces around the cutting elements. In addition, the relatively thin coating of the hardfacing may crack, peel off or wear, exposing the softer steel body that is then rapidly eroded. In addition, the hardfacing material may become a penetration limiter and a catch point for debris from the wellbore. Due to the high failure rates caused by the erosion undercutting of the steel body and poor coverage of hardfacing near and between the cutting element pockets, a typical steel body bit with hardfacing generally achieves only a few runs per bit.

Matrix bit bodies attempt to improve on steel drill bit body reliability and performance and are typically formed by embedding a steel blank or core in a carbide powder, (such as tungsten carbide), and infiltrating the particulate carbide material with a metallic binder material (such as a copper alloy). The drill bit formation process typically includes placing the steel blank or core and the carbide powder into a mold cavity. The mold is commonly formed of graphite and may be machined into various suitable shapes. The carbide powder may be a powder of a single material such as tungsten carbide, or it may be a mixture of more than one material such as different forms of tungsten carbide or tungsten carbide and other materials such as metal additives. Displacements are typically added to the mold to define cutting element pockets, nozzles, and other features. After the displacements are positioned in the mold, the powder is added. After the powder is added, the mold may be vibrated to remove voids in the powder, to ensure that the powder has penetrated down into the entire volume of the mold, and to improve powder packing.

In preparation for infiltration, a metallic binder material (e.g. a copper alloy) is typically placed over the powder. Infiltration consists of heating the mold and components within the mold. Heating causes the metallic binder material to melt and infiltrate the carbide powder. In addition to infiltrating the carbide powder, the binder material bonds to the grains of the carbide powder and to other components that it contacts, such as the steel blank or core embedded within the mold. A bit body is formed upon subsequent cooling and solidification of the contents of the mold.

The powder material or materials and the binder substantially determine the mechanical properties of the bit body. These mechanical properties include, but are not limited to, toughness (resistance to impact-type fracture), hardness, abrasion resistance, erosion resistance (including resistance to erosion from rapidly flowing drilling fluid), transverse rupture strength (TRS), and strength of the bond to the cutting elements (braze strength). Due to the extreme forces and stresses to which drill bits are subjected during drilling operations, the materials of an ideal drill bit must simultaneously exhibit high hardness, high abrasion resistance, high strength, and high fracture toughness. In reality however, materials that exhibit extremely high hardness and high abrasion resistance tend to be relatively brittle and do not exhibit high strength or high fracture toughness, while materials exhibiting high strength and high fracture toughness tend to be relatively soft and do not exhibit high hardness or high abrasion resistance. As a result, a compromise must be made between hardness and fracture toughness when selecting materials for use in drill bits.

Therefore, similar to steel bit bodies, it would be desirable to be able to simultaneously provide different mechanical properties in different regions of the matrix bit body. For a matrix bit body, this may be done by placing different powder materials into different locations of a mold for the matrix bit body. It is known in the industry to improve surface characteristics of a matrix bit by placing a hard, abrasion-resistant, erosion-resistant powder material adjacent to interior surfaces of a mold to form surfaces of the bit, and then adding a powder or combination of powders having properties of high strength and high fracture toughness to form the body of the bit.

FIG. 2A illustrates interior surfaces of a mold cavity 124 of mold 122 having a hard, abrasion-resistant, erosion-resistant powder or combination of powders (hereinafter “face powder 118”) adjacent to interior surfaces of the mold cavity 124 and around displacements 126. The interior surfaces of the mold cavity 124 adjacent to the face powder 118 correspond to exterior surfaces of the of the bit body 102 (as illustrated in FIG. 1) while the displacements 126 create cutting element pockets 116, allow for placement of nozzles 108, and allow for placement of internal fluid passageways etc. in the bit body 102.

FIG. 2B illustrates a cross-section of mold cavity 124 of mold 122. Face powder 118 is positioned adjacent to interior surfaces of the mold cavity 124 and around displacements 126 below dotted line 128 in the mold 122. After the face powder 118 powder is positioned, a powder or combination of powders having properties of high strength and high fracture toughness (hereinafter “body powder 120”) is disposed in the mold cavity 124 of the mold 122 on top of the face powder 118 above dotted line 128. Forming a bit body 102 (as illustrated in FIG. 1) out of two (or more) types of powder materials may allow the bit body 102 to have hard, erosion-resistant, abrasion resistant exterior surfaces while the interior of the bit body may have high strength and high fracture toughness. Unfortunately, the geometry of the bit (and the mold) make it difficult to precisely place different powder materials in different regions of a mold because the mold contains complex shapes and curved surfaces.

Furthermore, even if various different powders are placed correctly into different mold locations, the powders tend to shift and diffuse due to vibrations and gravity as the mold is processed in preparation for infiltration. Thus, there is little control over powder placement in a mold during mold preparation. Accordingly, in the conventional art for matrix drill bits, it is typical for a single powder composition to be chosen representing a compromise between the wear resistance material properties sought for the outer surfaces of the matrix bit body and the high strength and toughness material properties sought for the bulk of the matrix bit body.

### BRIEF SUMMARY

Accordingly, there exists a continuing need for the ability to precisely place different powders with different properties at different selected locations within a matrix bit body mold. In addition, there is a need for a way to ensure that once a powder is placed in a specific location, it will stay in that location while the mold is being processed in preparation for infiltration. This would allow for the production of matrix bit bodies in which properties for erosion resistance, abrasion resistance, and hardness etc. may be specifically enhanced in regions where those properties are desired.

Embodiments of the present disclosure generally relate to methods of manufacturing an earth boring tool including a tool body and blades extending radially from the tool body comprising: providing a mold, the mold comprising a mold cavity defining an interior surface corresponding to an exterior shape of the tool body and the blades. The methods further comprise forming at least one barrier sleeve insert and disposing the at least one barrier sleeve insert adjacent and spaced from an interior surface in the mold cavity. The method further comprises disposing a first powder in a gap between the at least one barrier sleeve insert and the interior surface in the mold cavity, disposing a second powder in the mold cavity, disposing an infiltrant material adjacent the first powder and the second powder, and heating the mold to melt and infiltrate the infiltrant material into the first powder and the second powder to form the tool body and the blades.

Other embodiments of the present disclosure include a mold assembly for manufacturing an earth boring tool, the mold comprising a mold cavity defining interior surfaces corresponding to an exterior shape of the tool body and the plurality of blades. At least one barrier sleeve insert is disposed adjacent and spaced from the interior surface of the mold cavity.

Other embodiments of the present disclosure include a mold assembly for manufacturing an earth boring tool, the mold comprising a mold cavity defining interior surfaces corresponding to an exterior shape of the tool body and the plurality of blades. At least one containment sleeve insert is disposed adjacent and spaced from the interior surface of the mold cavity.

### BRIEF DESCRIPTION OF THE DRAWINGS

FIG. 1 illustrates a fixed-blade earth-boring rotary drill bit that may be used in conjunction with the drilling system.

FIGS. 2A and 2B illustrate a mold cavity of a mold. In the mold cavity, a face powder is disposed adjacent to interior surfaces of the mold cavity and a body powder is disposed in the mold cavity after the face powder.

FIGS. 3A-3C illustrate three different embodiments of barrier sleeve inserts.

FIG. 4 depicts a simplified view of an example of an additive manufacturing 3D printer used to form barrier sleeve inserts from flowable (polymer) materials.

FIG. 5 illustrates an example of a polyjet system that passes a flowable material through a series of nozzles to form barrier sleeve inserts on a substrate.

FIG. 6 illustrates an example of a stereolithography (SLA) system that uses a laser to selectively cure photosensitive liquid to form barrier sleeve inserts on a base.

FIGS. 7A, 7B, and 7C illustrate barrier sleeve inserts disposed adjacent and spaced from the interior surfaces of a mold cavity of a mold.

FIG. 8A illustrates an embodiment of a barrier sleeve insert disposed adjacent and spaced from the interior surfaces of a mold cavity of a mold.

FIGS. 8B and 8C illustrate embodiments of barrier sleeve inserts configured with communication holes, and disposed adjacent and spaced from the interior surfaces of a mold cavity of a mold.

FIG. 9A illustrates a powder entirely contained within a containment sleeve insert.

FIGS. 9B and 9C illustrate containment sleeve inserts positioned adjacent interior surfaces of a mold cavity.

FIG. 10 schematically depicts an example of a process using an additive manufacturing powder bed to form barrier sleeve inserts from non-fluid powder materials.

FIGS. 11A and 11B illustrate cross-sections of one of a plurality of blades that was prepared using the prior art method of hand packing a hard, abrasion-resistant, erosion-resistant powder adjacent to interior surfaces in a mold cavity, adding a high-strength, high-toughness powder, and then infiltrating the powders to form the one of the plurality of blades.

FIGS. 11C and 11D illustrate cross-sections of one of a plurality of blades according to an embodiment of the invention, that was prepared by placing barrier sleeve inserts adjacent an interior surface of a mold cavity, disposing a hard, abrasion-resistant, erosion-resistant powder into the gap between the barrier sleeve inserts and the interior surface of the mold cavity, adding a high-strength, high-toughness powder, and then infiltrating the powders to form the one of the plurality of blades.

FIG. 12 is a flow chart showing a method for manufacturing an earth boring tool having hard, abrasion-resistant, erosion-resistant surfaces and an interior body that has high toughness and high-strength by using a mold comprising a mold cavity that has at least one barrier sleeve insert adjacent to interior surfaces of the mold cavity. The at least one barrier sleeve insert is configured to optimize placement of and restrict movement of powders in the mold such that the hard, abrasion-resistant, erosion-resistant powders are retained near the surface of the mold during processing.

### DETAILED DESCRIPTION

The illustrations presented herein are not actual views of any particular cutting assembly, tool, or drill string, but are merely idealized representations employed to describe example embodiments of the present disclosure. The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are not drawn to scale. Additionally, elements common between figures may have corresponding numerical designations.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

As used herein, the term “earth-boring tool” means and includes any type of bit or tool used for drilling during the formation or enlargement of a wellbore and includes, for example, rotary drill bits, percussion bits, core bits, eccentric bits, bi-center bits, reamers, mills, drag bits, roller-cone bits, hybrid bits, and other drilling bits and tools known in the art.

As used herein, the term “hard material” means and includes any material having a Knoop hardness value of about 1,000 Kgf/mm2 (9,807 MPa) or more. Hard materials include, for example, diamond, cubic boron nitride, boron carbide, tungsten carbide, etc.

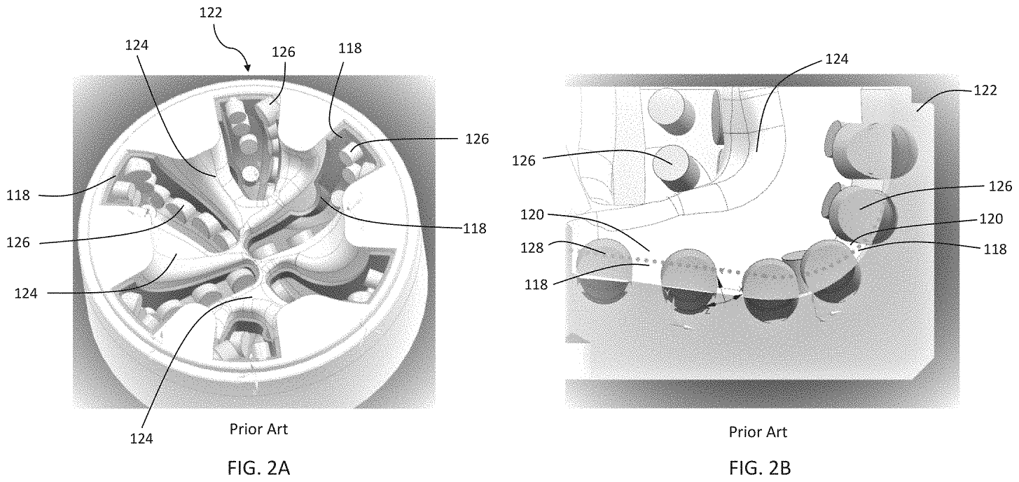

As described above and illustrated in FIGS. 2A and 2B, it is known in the industry to position a face powder 118 adjacent to interior surfaces of a mold cavity 124. However, this operation requires that the face powder 118 be hand packed adjacent to interior surfaces of the mold cavity 124. After the face powder 118 is hand packed into the mold cavity 124, a body powder 120 may be added into the mold cavity 124. Unfortunately, packing a face powder 118 adjacent to interior surfaces of a mold cavity 124 by hand is an imperfect process. Furthermore, even if the face powder 118 is precisely and correctly placed in the mold cavity 124, the face powder 118 may tend to shift as the body powder 120 is added to the mold cavity 124, and as the mold 122 is vibrated to remove voids in the powders. Thus, there is a need for an improved method of placing the face powder 118 accurately and consistently into the mold cavity 124. There is also a need for a way to restrain the face powder 118 and to prevent it from shifting within the mold cavity 124 after it has been placed in the mold cavity 124.

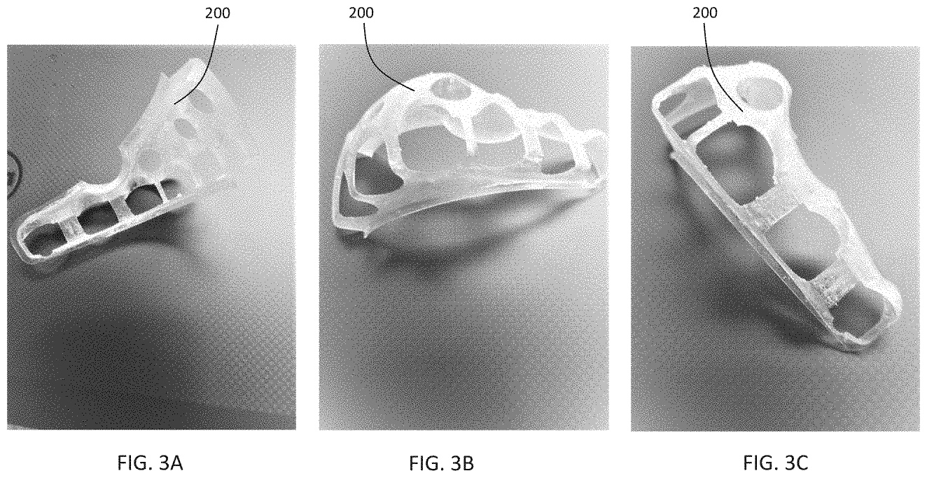

FIGS. 3A-3C illustrate three different embodiments of barrier sleeve inserts 200. The barrier sleeve inserts 200 are configured for placement within mold cavity 124. The barrier sleeve inserts 200 may be formed using an additive manufacturing process in which multiple layers of material are deposited to build the geometry of the barrier sleeve inserts 200.

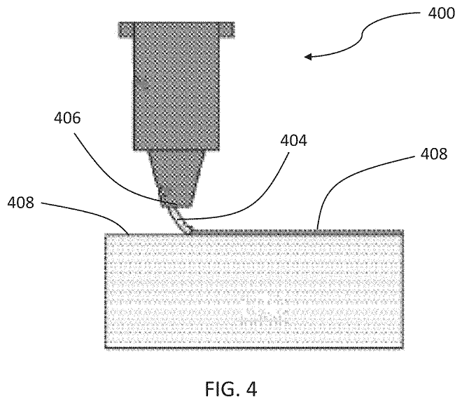

FIG. 4 is illustrates an example of an additive manufacturing device 400 used to form barrier sleeve inserts 200 (as illustrated in FIGS. 3A-3C). Barrier sleeve inserts 200 may be formed from a flowable (polymer) material 404 using the additive manufacturing device 400. There are numerous commercially available devices that may be used in additive manufacturing. In some embodiments, the additive manufacturing device 400 may be a three-dimensional (3D) printer.

In some embodiments, the barrier sleeve inserts 200 are created by passing a flowable material 404 through one or more nozzles 406 of the additive manufacturing device 400 and depositing the flowable material layer by layer onto a substrate 408. The additive manufacturing device 400 may deposit one or more subsequent layers having dimensions corresponding to the dimensions of the adjacent and previously deposited layer, such that the cross sectional shape of the finished part is uniform. In other embodiments, the additive manufacturing device 400 may deposit one or more subsequent layers having dimensions that are different from the dimensions of the adjacent and previously deposited layers, such that the dimensions and/or the cross sectional shape of the finished component may vary.

In some embodiments, forming the barrier sleeve inserts 200 (as shown in FIGS. 3A-3C) using additive manufacturing, includes depositing or forming a first layer of a material mixture on a substrate 408 and depositing or forming multiple successive layers at least partially adjacent the first layer. In some embodiments, the successive layers may include a material mixture that is the same as that used in the deposition of the first layer. In other embodiments, at least one of the successive layers may include a substantially different material.

As used herein, the word “substrate” may refer to a platform or base that is separate from but that supports the barrier sleeve inserts 200 as they are manufactured. The word “substrate” may also refer to any layer of the barrier sleeve inserts 200 that has a second or subsequent layer deposited thereon, depending on the stage of manufacture. For example, manufacturing barrier sleeve inserts 200 may include depositing a first layer on a substrate 408 or base that is separate from the component. The first layer may then be the substrate for a second or subsequent layer deposited thereon.

The additive manufacturing device 400 may fabricate the barrier sleeve inserts 200 from a digital design of a CAD system in one process, or the additive manufacturing device 400 may fabricate the barrier sleeve inserts 200 in two or more processes. For example, the barrier sleeve inserts 200 may be formed by fabricating separate pieces of the barrier sleeve inserts 200 and then assembling the separate pieces together to form the barrier sleeve inserts 200.

In some embodiments, the material used for depositing multiple layers to build the barrier sleeve inserts' 200 geometry may comprise a polymer material. In some embodiments the polymer material may be formulated such that it will burn out at infiltration pre-heat temperatures. Furthermore, different forms of flowable material 404 may be deposited using various types of additive manufacturing devices to build the geometry. For example, material deposition by the additive manufacturing device 400 may include the spraying of gels, liquids, or slurries; printing of gels, slurries, or solids; spreading of solids or gels; fusing of liquids or solids; melting of solids; and solidification of liquids using a wide range of techniques.

In some embodiments, multiple types of materials (for example, materials having a difference in shape, size, or chemical composition) may be applied as a single layer by multiple passes of the additive manufacturing device 400. For example, a first composition (having a first shape, size, and/or chemical composition) may be deposited by the additive manufacturing device 400 in a first region of a layer, and a second composition (having a second shape, size, and/or chemical composition) may be deposited by a separate pass of the additive manufacturing device 400 in a second region of the layer, such that the deposited layer has at least two distinct regions formed of the first composition and the second composition.

In other embodiments, a material mixture of a first composition and second composition (the first composition having at least a different shape, size, or chemical composition than the second composition) may be deposited in a single pass of the additive manufacturing device 400, or may be deposited sequentially in two passes of the additive manufacturing device 400. For example, the additive manufacturing device 400 may have two or more nozzles 406, where each of the nozzles 406 may deposit a different material in a different region of the layer in separate passes. In other embodiments, a material mixture of a first composition and a second composition may be deposited homogenously. In some embodiments, the additive manufacturing device 400 may have two or more nozzles 406, where each of the nozzles 406 may deposit a different material simultaneously during a single pass to form a layer of composite material, (e.g., a combination of ceramic material and an adhesive or an organic binder).

In some embodiments, a multi-nozzle extruder having at least one row of nozzles may be used to form barrier sleeve inserts from a flowable polymer using the “polyjet” process. The polyjet process (or material jetting system) is described in patent U.S. Pat. No. 6,259,962 B1 to Gothait, and is incorporated by reference herein. In some embodiments, the polyjet system may comprise an array of nozzles.

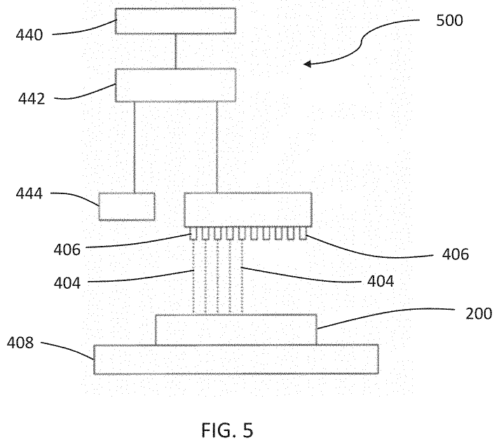

FIG. 5 illustrates an example of a polyjet system 500 used to form barrier sleeve inserts 200 on a substrate 408 in which the barrier sleeve inserts 200 are created by passing a flowable material 404 through a series of nozzles 406 of the polyjet system 500 and depositing the flowable material layer by layer onto a substrate 408. In some embodiments, a size of an aperture in each of the nozzles 406 can be adjusted to adjust the amount of material deposited by the nozzles 406. In some embodiments, the depth of each layer may be controllable by selectively adjusting the output from each of the plurality of nozzles 406. In some embodiments, the amount of material extruded from each of the nozzles 406 may be adjusted to compensate for variations in one or more preceding layers prior to depositing a subsequent layer. In some embodiments, one or more subsequent layers having dimensions corresponding to the dimensions of the adjacent and previously deposited layer, may be deposited such that the cross sectional shape of the finished part is uniform. In other embodiments, one or more subsequent layers may be deposited that have dimensions that are different from the dimensions of the adjacent and previously deposited layers, such that the dimensions and/or the cross sectional shape of the finished component may vary.

In some embodiments, the polyjet system 500 may be controlled using a Computer Aided Design (CAD) system 440 coupled to a process controller 442. In some embodiments, the polyjet system 500 may also comprise a curer 444 in which the barrier sleeve inserts 200 may be cured with heat (including infrared radiation) or UV light. In some embodiments, cured barrier sleeve inserts 200 may be handled and used immediately, without post-cure processioning.

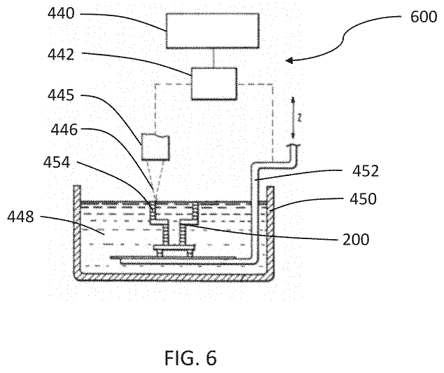

In some embodiments, stereolithography may be used to produce a barrier sleeve insert. FIG. 6 illustrates an example of a stereolithography system 600 that uses a laser 445 to selectively cure photosensitive liquid 448 into a desired form in sequential layers. Stereolithography is widely recognized as the first 3D printing process and first to be commercialized and is generally accepted as being one of the most accurate 3D printing processes. Limiting factors for stereolithography include the fact that post-processing steps may be required and that the materials can become more brittle over time. Stereolithography is described in U.S. Pat. No. 4,575,330 B1, to Charles Hull, which is incorporated by reference herein.

In stereolithography (SLA), a photosensitive liquid 448 is held in a vat 450 with a movable platform 452 inside. A laser beam 446 is directed across a surface 454 of the photosensitive liquid 448 according to the 3D data supplied to a process controller 442 by a CAD system 440. The photosensitive liquid 448 hardens precisely where the laser hits the surface of the photosensitive liquid 448. Once the layer is completed, the movable platform 452 within the vat 450 drops down by a thickness of one layer (in the z axis) and a subsequent layer is traced out by the laser beam 446. This continues until the barrier sleeve insert 200 is completed and the movable platform 452 can be raised out of the vat 450. In some embodiments, the barrier sleeve inserts 200 may need to be cleaned and/or cured after it is formed. Curing may involve subjecting the part to heat and/or light in an oven-like machine to fully harden the resin.

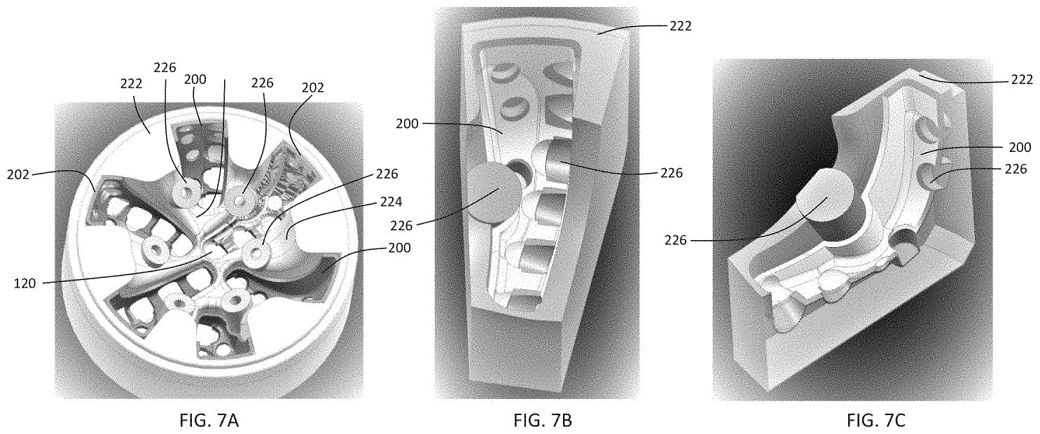

FIGS. 7A, 7B and 7C illustrate barrier sleeve inserts 200 disposed adjacent and spaced from the interior surfaces of a mold cavity 224 of a mold 222. Each of the barrier sleeve inserts 200 may be individually configured to fit a specific designated interior surface of a mold cavity 224 and around displacements 226. After the barrier sleeve inserts 200 are disposed adjacent and spaced from the designated interior surfaces of the mold cavity 224, a face powder 118 may be disposed in a gap 202 between the barrier sleeve inserts 200 and the interior surface of the mold cavity 224. The barrier sleeve inserts 200 may be used to ensure precise placement of the face powder 118. The barrier sleeve inserts 200 may also minimize movement of the face powder 118 as the mold is vibrated to prepare the mold 222, the face powder 118, and the body powder 120 for infiltration.

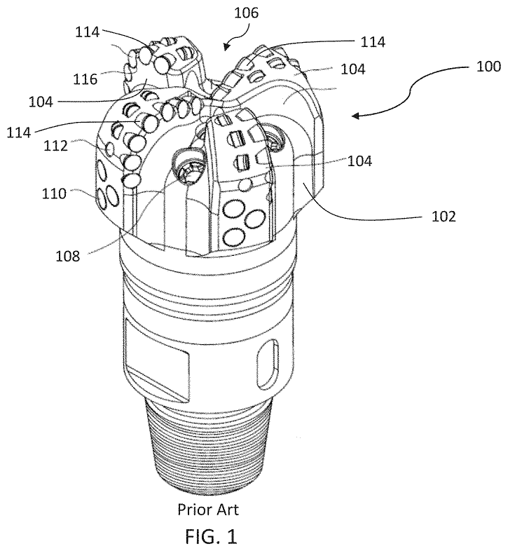

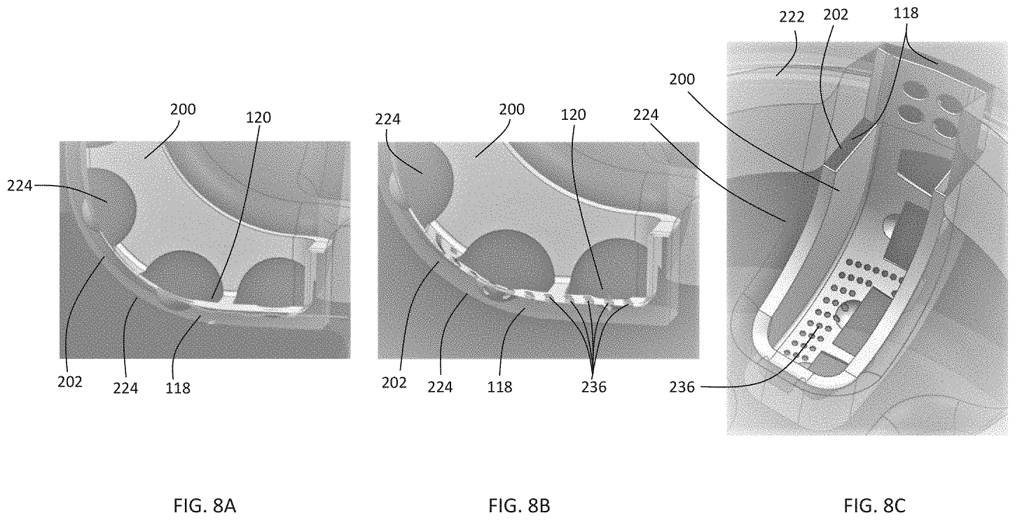

FIG. 8A illustrates an embodiment of a barrier sleeve insert 200, disposed adjacent and spaced from an interior surface of a mold cavity 224 of a mold 222, that has does not have communication holes. Testing has shown that the vibration process may cause settling and packing of the face powders below the barrier sleeve inserts 200 and that this may cause a binder rich region in the drill bit (100 as illustrated in FIG. 1) after infiltration. Therefore, in some embodiments, barrier sleeve inserts 200 may be configured with communication holes 236 that allow the body powder 120 to flow through the barrier sleeve inserts 200 and prevent binder rich zones after infiltration.

FIGS. 8B, and 8C illustrate barrier sleeve inserts 200, which have communication holes 236. Barrier sleeve inserts 200 may be disposed adjacent and spaced from interior surfaces of a mold cavity 224 of a mold 222. In FIGS. 8A, 8B, and 8C, the face powder 118 is placed between the barrier sleeve inserts 200 and the interior surfaces of a mold cavity 224. The body powder 120 is placed above the barrier sleeve inserts 200.

In some embodiments, the barrier sleeve inserts 200, may be formed from a polymer material configured to melt, evaporate, or burn out at infiltration pre-heat temperatures. In some embodiments, heating mold 222 (containing the barrier sleeve inserts 200) will melt, burn, or evaporate the barrier sleeve inserts 200, ensuring precise proper placement and retention of face powder 118 and body powder 120 in mold 222 until the bit body is infiltrated and formed.

In some embodiments, the barrier sleeve inserts 200 may comprise a copper alloy. In some embodiments, heating the mold 222 containing the barrier sleeve inserts 200 will melt the copper alloy from barrier sleeve inserts 200 (along with the rest of the infiltrant), and will infiltrate the surrounding powder particles, thus forming a bit body. After infiltration, the bit body may be removed for cleaning and other processing in preparation for use.

In some embodiments, the barrier sleeve inserts 200 may comprise a hard, abrasion-resistant, erosion-resistant powder or combination of powder materials bound together with a glue, polymer binder, or other material.

In some embodiments, the same face powder 118 may be disposed in the gap 202 between each of the barrier sleeve inserts 200 and the interior surfaces of the mold cavity 224. In other embodiments, face powders having different compositions and different material properties may be disposed at different locations in the mold cavity 224. For example, material properties that are desired around the nozzles 108 in the bit body 102 (as illustrated in FIG. 1) may be different from the material properties that are desired adjacent to the cutting element pockets 116, or the material properties that are desired in the surfaces defining the junk slots 106, etc. Thus it may be desirable to configure each of the barrier sleeve inserts 200 specifically for each mold cavity 224 location to ensure proper placement and retention of a unique face powder 118 at that location. The face powder 118 (or powders) may then be specifically configured to provide the specific properties that are desired at a particular surface or region of the bit body 102. Thus, the surfaces of the bit body may be configured to have the exact properties that are desired at any particular location.

In some embodiments, the barrier sleeve inserts 200 may be stacked such that the barrier sleeve inserts 200 are disposed one on top of another with a gap between adjacent barrier sleeve inserts 200. In some embodiments, a different face powder composition may be disposed in each gap. In some embodiments, this may create a bit body having various material compositions near the exterior surface of the bit body. In some embodiments, the different material compositions could combine to create a graded surface (or portion of the bit body) such that at least a portion of the outer surface of the bit body comprises a very hard, erosion-resistant, and abrasion resistant material, while gradually transforming to a body material of the bit body having high strength and toughness.

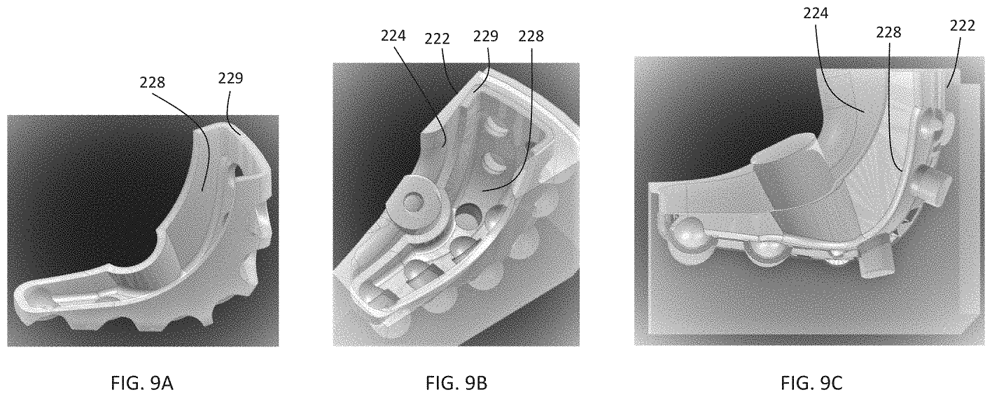

FIG. 9A illustrates an embodiment of a barrier sleeve insert in which a first powder 229 is fully surrounded by the insert. This is hereinafter referred to as containment sleeve insert 228. The containment sleeve insert 228 comprises a hollow barrier sleeve insert that may be filled with a hard, abrasion-resistant, erosion-resistant powder or combination of powder materials (e.g. a first powder 229). In some embodiments, the first powder 229 may comprise a carbide powder.

FIGS. 9B and 9C illustrate embodiments of containment sleeve inserts 228 adjacent to interior surfaces in mold cavity 224 of mold 222. Placement of the containment sleeve inserts 228, adjacent to interior surfaces in mold cavity 224 may allow the first powder 229 to be placed and retained in a precise location until the powders are infiltrated and solidified. The containment sleeve inserts 228 may be filled with the first powder 229 before or after they are placed adjacent to an interior surface of the mold cavity 224 of the mold 222.

In some embodiments, the containment sleeve inserts 228 may be made from a polymer material. In some embodiments, the polymer material may be configured to melt, burn, or evaporate out at pre-heat temperatures. In some embodiments, heating mold 222 (containing the containment sleeve inserts 228) will melt, burn, or evaporate the containment sleeve inserts 228, thereby ensuring precise proper placement and retention of the first powder 229 in mold 222 until the bit body is infiltrated and formed.

In some embodiments, the containment sleeve inserts 228 may be made from a copper alloy. In some embodiments, heating the mold containing the containment sleeve inserts 228 will melt the copper alloy from containment sleeve inserts 228 (along with the rest of the infiltrant), and will infiltrate the surrounding powder particles, thus forming a bit body. After infiltration, the bit body may be removed for cleaning and other processing in preparation for use.

In some embodiments, the containment sleeve inserts 228 may comprise a hard, abrasion-resistant, erosion-resistant powder or combination of powder materials bound together with a glue, polymer binder, or other material.

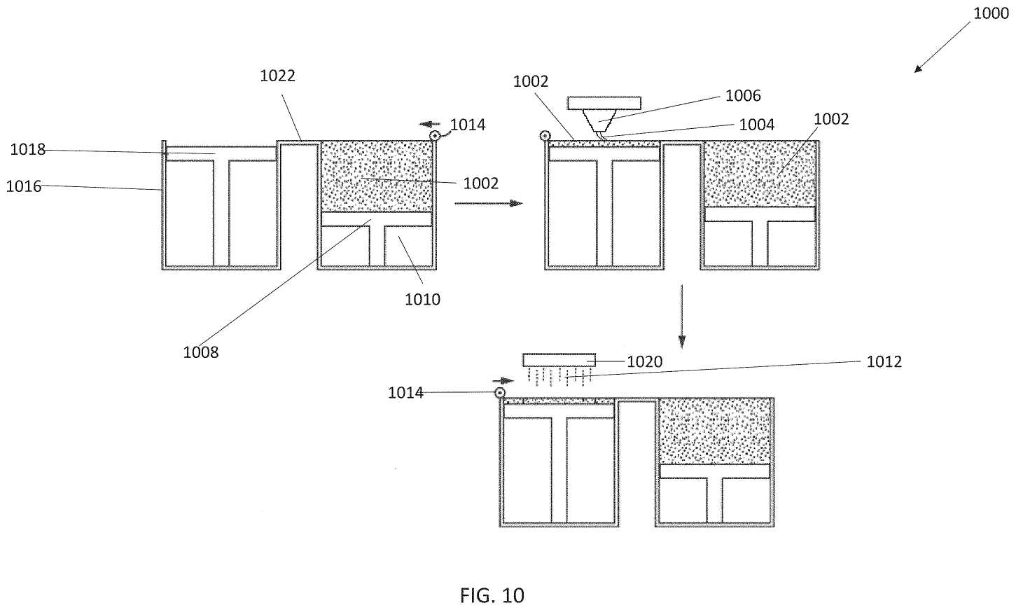

FIG. 10 schematically depicts an example of a powder bed process 1000. Powder bed processing may be applicable when the barrier sleeve inserts 200 (as illustrated in FIGS. 3A, 3B, and 3C) or containment sleeve inserts 228 (as illustrated in FIGS. 9A, 9B, and 9C) will be formed out of a non-fluid material such as a powder. For example, in some embodiments, the barrier sleeve inserts 200 may be formed from a hard, abrasion-resistant, erosion-resistant powder or combination of powder materials comprising a ceramic hard material such as tungsten carbide powder. In some embodiments, the barrier sleeve inserts 200 may be formed from a metal powder. In some embodiments, the barrier sleeve inserts 200 may be formed from a metal powder comprising a copper based alloy. In some embodiments, the barrier sleeve inserts 200 may comprise more than type of powder.

In some embodiments, the hard, abrasion-resistant, erosion-resistant powder or combination of powder materials may be bound together with a polymer (or other) binder in powder bed process 1000 to form barrier sleeve inserts 200 that are placed into a mold cavity 224 similar to how the containment sleeve inserts of FIGS. 9B and 9C are placed into the mold cavity 224. In some embodiments, a flowable binder material 1004, used in powder bed process 1000 to form the barrier sleeve inserts 200, may be configured to melt, evaporate, or burn out at infiltration pre-heat temperatures.

In the first step of powder bed process 1000, a layer of loose powder particles 1002 from a first powder chamber 1010 containing loose powder particles 1002, and a first movable piston 1008, is deposited in a build box 1022 in a second powder chamber 1016 with a second movable piston 1018 via a movable arm 1014.

Nozzle 1006 may deposit an adhesive or a flowable binder material 1004 to the specific areas of the layer of loose powder particles 1002 in second powder chamber 1016 where the barrier sleeve inserts 200 will be. After the application of the adhesive or flowable binder material 1004 to the layer of powder particles 1002, heat or UV light 1012 may be applied by a source 1020 to cure the adhesive or flowable binder material 1004. Another layer of loose powder particles 1002 may then be spread across the second powder chamber 1016, followed by another pass of flowable binder material 1004 on the designated areas of the new layer of loose powder particles 1002, and another application of heat or UV light 1012, to form a second layer of one or more of the barrier sleeve inserts 200. The process is repeated and the repetitive layering process results in one or more layer on layer, three-dimensional (3D) barrier sleeve inserts 200.

In powder bed processing, the minimum thickness of the layers is limited by the particle size of the material that is being layered, with the minimum layer thickness being equal to or greater than the diameter of the particular powder material being layered. For example, in some embodiments, each layer may have a thickness ranging from about 10 μm to about 1000 μm. The layer of powder particles 1002 should be of substantially uniform thickness and may have any thickness up to about 1 millimeter, as long as the flowable binder material 1004 can bind all the loose powder of the layer of powder particles 1002. The number of distinct layers typically varies, for example, from a lower limit of less than about 5 to an upper limit of greater than 100. However, any layer thickness and any suitable number of layers may be used.

In general, the particle size of the powdered materials may be from about 10 nm to about 400 μm (e.g., the particles may have a diameter or longest dimension within this range). In some embodiments, the particle size of the powdered materials may be from about 1 μm to about 200 μm. In some embodiments, the particle size of the powdered materials may be at least about 50 μm, e.g., from about 50 μm to about 200 μm. In some embodiments, the particle size of the powdered materials may be from about 50 μm to about 100 μm.

In some embodiments, the powdered materials may be granulated prior to their deposition and a first powder composition could be granulated with a second powder composition prior to deposition. The granulated powders may be substantially spherical and possess diameters as described above (e.g., about 10 nm to about 400 μm, about 1 μm to about 200 μm, or about 50 μm to about 100 μm, etc.). For example, in some embodiments, granulated powders may be formed by the granulation of a single material, while in other embodiments, granulated powders may be formed by the granulation of at least two different materials (having a difference in at least one of shape, size, or chemical composition). The term “powder material” as used herein may be a single powder, a single granulated material, a blend of two or more powders, or a mixture formed by the granulation of at least two different materials. During the granulation of at least two different materials, the materials may form a substantially homogenous granule.

The powder materials used for additive manufacturing of the barrier sleeve inserts 200 may be any suitable materials for the desired end use. Further, in some embodiments, the powdered materials may include metals, metal alloys, metal oxides, metal carbides, metal borides, metal nitrides, or metal silicates (where metal includes metals and semi-metals, such as silicon). In some embodiments, the powdered materials may include metals such as silicon, titanium, tantalum, molybdenum, tungsten, copper, and copper alloys etc. In some embodiments, the powdered materials may include carbides such as tungsten carbide. In some embodiments, the powdered materials may include silicon dioxide (silica), zirconium silicate (zircon), silicon carbide, aluminum nitride, amorphous carbon, or graphite. However, any suitable materials can be used.

The additive manufacturing assembly described herein may be any suitable device suitable for fabricating an investment casting or mold using a CAD or other model as a template or guide. An additive manufacturing process for barrier sleeve inserts 200 for placement into the cavity of a mold 222 (as illustrated in FIGS. 7A, 7B, and 7C) may begin by taking a CAD model of the barrier sleeve inserts 200 for placement into the cavity of a mold and determining proper placement within the build box. In some embodiments, multiple CAD models of each of the barrier sleeve inserts 200 may be arrayed within a build box to maximize the efficiency of the additive manufacturing process by forming one or more barrier sleeve inserts 200 during the same deposition session.

As described above, at least one binder or adhesive may be provided during manufacturing to bind the first layer and successive layers together to form the component geometry. For example, a binder may be coated onto, or mixed within the material being deposited prior to its deposition, such that the binder is deposited simultaneously with the material being deposited by the additive manufacturing device, or a binder may be deposited separately from the remaining material being deposited. In some embodiments, a separate layer of binder or adhesive may be deposited before or after a layer of the powder material that will form the component is deposited. After building the bit component preform, the binder may be removed from the component, for example, by heating or by chemical decomposition.

After the barrier sleeve inserts 200 are formed, further processing may include cleaning the barrier sleeve inserts 200 to remove any material composition that is loosely connected or is otherwise not bound to the barrier sleeve inserts 200. In some embodiments, further processing may include heating to aid in the curing and consolidation of the barrier sleeve inserts 200 into a solid and suitably bound together mass suitable for its intended function. In some embodiments, the barrier sleeve inserts 200 may be infiltrated to further strengthen the bond of the material composition. For example, in some embodiments, tungsten powder may be infiltrated with a copper based alloy to strengthen the component.

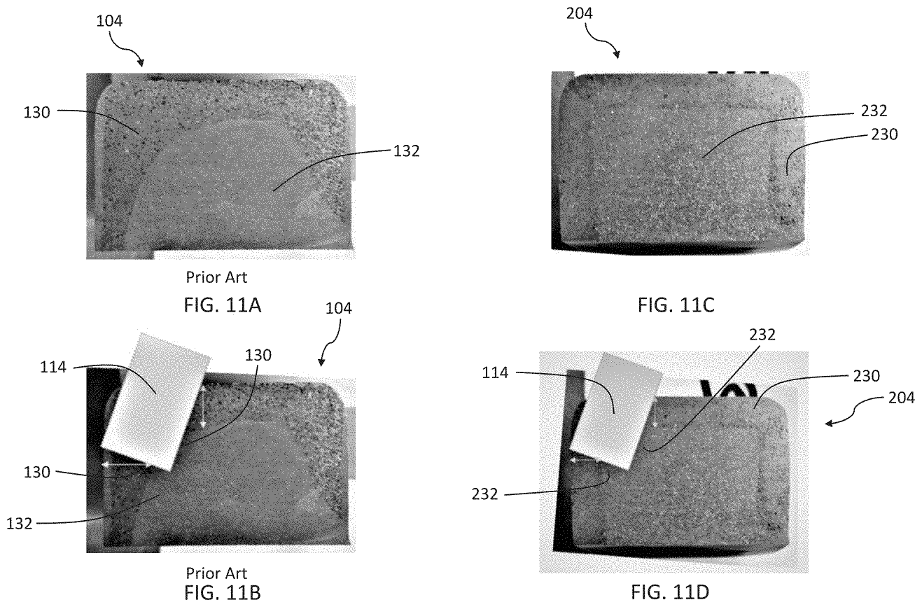

FIGS. 11A and 11B illustrate a cross-section of one of a plurality of blades 104 having a hard, erosion-resistant face material 130 formed by hand-packing a face powder 118 in a mold cavity 124 (as illustrated in FIG. 2A). FIGS. 11A and 11B also illustrate a high-strength high-toughness body material 132 comprising an interior of one of the plurality of blades 104. FIGS. 11A and 11B, show that the hard, erosion-resistant face material 130 has formed a layer around a periphery of one of the plurality of blades 104 that is relatively thick. Furthermore, FIGS. 11A and 11B illustrate that the hard, erosion-resistant face material 130 has a non-uniform thickness around the periphery of the one of the plurality of blades 104.

FIG. 11B illustrates a dummy cutting element insert 115, in one of the plurality of blades 104, that is almost entirely surrounded by the hard, erosion-resistant face material 130. As described above, the hard, erosion-resistant face material 130 is usually more brittle, has a lower strength, and is not as tough as the high-strength body material 132. Therefore, a cutting element mounted in the same manner as the dummy cutting element insert 115 will encounter formation material, and transmit shocks and vibrations to the one of the plurality of blades 104, it may cause the brittle, hard, erosion-resistant face material 130 to crack or, fracture because the cutting element is not adequately supported by the high-strength body material 132.

FIGS. 11C and 11D illustrate a cross-section of one of a plurality of blades 204 having a hard, erosion-resistant face material 230 formed according to one embodiment using barrier sleeve inserts 200 (as illustrated in FIGS. 3A-3C), to position a face powder 118 and a body powder 120. FIGS. 11C and 11D, illustrate that the hard, erosion-resistant face material 230 has formed a uniform surface around a periphery one of the plurality of blades 204 that is thinner than the prior art hard, erosion-resistant, face material 130 of FIGS. 11A and 11B.

FIG. 11D illustrates a location of a dummy cutting element insert 115 in one of the plurality of blades 204. The thinner layer of hard, erosion-resistant face material 230, allows the high-strength body material 232 to more substantially support a cutting element mounted in the same manner as dummy cutting element insert 115. This improvement is expected to reduce the likelihood of cracks and fractures of the hard, erosion-resistant face material 230 around the cutting element as it will encounter formation material, thus improving the reliability and durability of cutting element 114 and the reliability and durability of the plurality of blades 204.

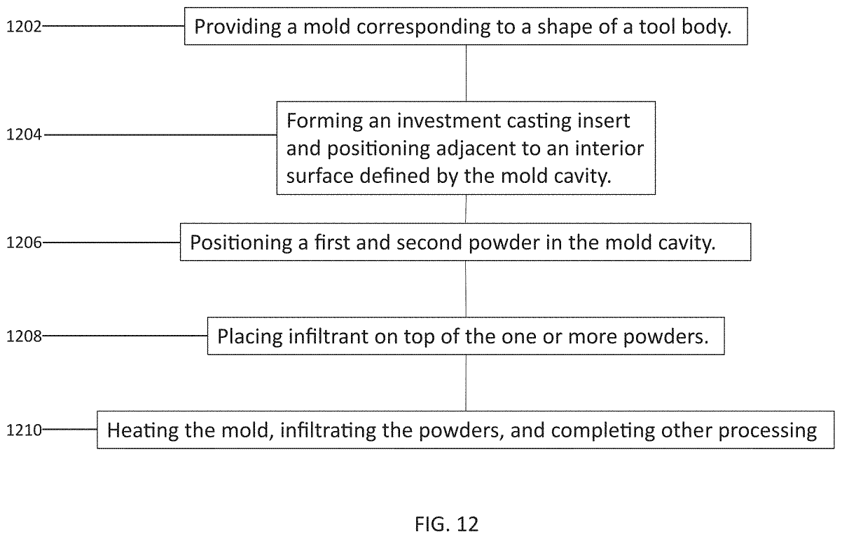

FIG. 12 shows a method of manufacturing an earth boring tool wherein the tool body has hard, abrasion-resistant, erosion-resistant surfaces and the interior of the bit body has high toughness and high strength. The first step 1202, is providing a mold wherein an interior cavity of the mold defines an interior surface that corresponds to the shape of the bit body. The second step 1204 is forming the barrier sleeve inserts and affixing the barrier sleeve inserts adjacent an interior surface of the mold cavity. The third step 1206 is placing a first powder in the gap between the barrier sleeve inserts and the interior surface of the mold cavity and then placing a second powder into the mold cavity.

In some embodiments, the first powder may form the surface of the bit body in areas where the bit body is subjected to high abrasion and erosion. In some embodiments, the first powder may be a hard material having high abrasion and erosion resistance. In some embodiments, the second powder may form the bulk of the interior material of the bity body. In some embodiments, the second powder is preferably made of a material having high strength and high toughness and will comprise the bulk of the interior of the bit body and the blades of the bit body. In some embodiments, the barrier sleeve inserts may be configured to aid in placing the first powder into desired locations in the mold with precision. In some embodiments, the barrier sleeve inserts may also prevent the first powder from shifting as the second powder is added and as the mold is vibrated to remove voids in the powders.

The fourth step 1208 is placing an infiltrant onto the top of the mold. Typically, the infiltrant comprises a copper alloy.

The fifth step 1210 is heating the mold. In some embodiments, heating the mold may melt, burn (oxidize), or evaporate the barrier sleeve inserts leaving the first and second powders properly positioned for infiltration. Further heating will melt the infiltrant thereby infiltrating the powders and forming the bit body. After infiltration, the bit body may be removed for cleaning and other processing in preparation for use.

In some embodiments, the barrier sleeve inserts may be made from a polymer material. In some embodiments, the polymer material may be formulated to become liquid or gas (e.g. to melt, burn, or evaporate out) at pre-heat temperatures. In some embodiments, heating the mold (containing the barrier sleeve inserts) will melt, burn, or evaporate the barrier sleeve inserts, thereby ensuring precise proper placement and retention of the powders in the mold until the bit body is infiltrated and formed.

In some embodiments, the barrier sleeve inserts may be made from a copper alloy. In some embodiments, heating the barrier sleeve inserts will melt them (along with the rest of the infiltrant) and will infiltrate the surrounding powder particles, thus forming the bit body. After infiltration, the bit body may be removed for cleaning and other processing in preparation for use.

In some embodiments, the barrier sleeve inserts may be formed from powder particles, such as carbide. In some embodiments, heating the barrier sleeve inserts formed from powder particles will melt, burn (oxidize), chemically remove, or evaporate the adhesive or binder holding the barrier sleeve inserts together. The melted, burned, or evaporated glue will be removed leaving the powders properly positioned for infiltration. Further heating will melt the metal infiltrant thereby infiltrating the powders and forming the bit body. After infiltration, the bit body may be removed for cleaning and other processing in preparation for use.

In some embodiments, a containment sleeve insert may be dispositioned on an interior surface of a mold. A containment sleeve insert comprises a hollow barrier sleeve insert that may be filled with a hard, abrasion-resistant, erosion-resistant powder. The powder may be placed into the containment sleeve insert before or after the containment sleeve insert is placed into the mold cavity adjacent an interior surface of the mold cavity. In some embodiments, the containment sleeve insert may be made from a polymer material configured to melt, burn, or evaporate out at pre-heat temperatures. Thus when the sleeve, containing the first powder is placed into the mold, the first powder is precisely positioned and retained in the proper position until heat is applied melting, burning or evaporating the sleeve and leaving the powders properly positioned for infiltration.

In some embodiments, the containment sleeve insert may be made from a copper alloy. In some embodiments, heating the containment sleeve insert will melt them and the copper alloy from containment sleeve insert (along with the rest of the infiltrant) will infiltrate the surrounding powder particles, thus forming the bit body. After infiltration, the bit body may be removed for cleaning and other processing in preparation for use.

In some embodiments, such as when the containment sleeve inserts are formed from powder particles, such as carbide, heating the containment sleeve insert will melt, burn (oxidize), chemically remove, or evaporate the adhesive or binder holding the containment sleeve inserts together. The melted, burned, or evaporated glue will be removed leaving the powders properly positioned for infiltration. Further heating will melt the metal infiltrant thereby infiltrating the powders and forming the bit body. After infiltration, the bit body may be removed for cleaning and other processing in preparation for use.

In example embodiments, the mold is configured to produce a typical rotary-type drag bit. Those skilled in the art, however, will appreciate that the size, shape, and/or configuration of the bit may vary according to operational design parameters without departing from the spirit of the present invention. Further, the invention may be practiced on non-rotary drill bits, the invention having applicability to any drilling-related structure including percussion, impact or “hammer” bits. Moreover, although this invention has been described with respect to steel core matrix bits, those skilled in the art will appreciate this invention's applicability to drill bits manufactured from other metals and alloys thereof, and other suitable materials.

Those skilled in the art will appreciate that references to the use of ceramic, steel, or other metallic powders could include powders of various mesh sizes. It will also be appreciated by one of ordinary skill in the art that one or more features of any of the illustrated embodiments may be combined with one or more features from another embodiment to form yet another combination within the scope of the invention as described and claimed herein. Thus, while certain representative embodiments and details have been shown for purposes of illustrating the invention, it will be apparent to those skilled in the art that various changes in the invention disclosed herein may be made without departing from the scope of the invention, which is defined in the appended claims.

Those skilled in the art will also appreciate that various mold configurations and materials can be used without departing from the scope of this invention and more particularly to the scope of the appended claims. For example, the mold 122 of FIG. 2 may include a casing comprised of graphite, ceramic, sand, clay, silicon carbide, tufa and/or other suitable materials known in the art that can withstand the high temperatures encountered during the infiltration process.

Additional non-limiting example embodiments of the disclosure are described below.

Embodiment 1: A method of manufacturing an earth boring tool including a tool body and blades extending radially from the tool body comprising: providing a mold, the mold comprising a mold cavity defining an interior surface corresponding to an exterior shape of the tool body and the blades; forming at least one barrier sleeve insert and securing the at least one barrier sleeve insert adjacent and spaced from an interior surface in the mold cavity; disposing a first powder in a gap between the at least one barrier sleeve insert and the interior surface in the mold cavity, disposing a second powder in the mold cavity, disposing an infiltrant material adjacent the first powder and the second powder, and heating the mold to infiltrate the infiltrant material into the first powder and the second powder to form the tool body and the blades.

Embodiment 2: The method of Embodiment 1, further comprising, forming the at least one barrier sleeve insert using an additive manufacturing process.

Embodiment 3: The method of any of Embodiments 1 and 2, further comprising, forming the at least one barrier sleeve insert using a three-dimensional (3D) printer.

Embodiment 4: The method of any of Embodiments 1 through 3, further comprising, forming the at least one barrier sleeve insert out of a material chosen from a group comprising: polymer, paper, resin, ceramic, composite, and metal or metal alloy.

Embodiment 5: The method of any of Embodiments 1 through 4, further comprising, forming the at least one barrier sleeve insert from a polymer material.

Embodiment 6: The method of any of Embodiments 1 through 5, wherein the polymer material is formulated to become a liquid or a gas at or below infiltration temperatures.

Embodiment 7: The method of any of Embodiments 1 through 6, further comprising, forming the at least one barrier sleeve insert from a carbide material.

Embodiment 8: The method of any of Embodiments 1 through 7, further comprising, forming the at least one barrier sleeve insert using a powder bed process.

Embodiment 9: The method of any of Embodiments 1 through 8, further comprising, forming communication holes in the at least one barrier sleeve insert.

Embodiment 10: The method of any of Embodiments 1 through 9, further comprising, disposing at least two barrier sleeve inserts on top of each other in the mold cavity.

Embodiment 11: The method of any of Embodiments 1 through 10, further comprising disposing at least a third powder in the gap or gaps created by disposing the at least two barrier sleeve inserts on top of each other, thereby creating a transition region between the first powder and the second powder.

Embodiment 12: A mold assembly for manufacturing an earth boring tool, the mold comprising a mold cavity defining an interior surface in the mold and at least one barrier sleeve insert disposed adjacent and spaced from the interior surface of the mold cavity.

Embodiment 13: The mold assembly of Embodiment 12, wherein the at least one barrier sleeve insert is configured to optimize placement of at least one powder placed within the mold cavity.

Embodiment 14: The mold assembly of any of Embodiments 12 and 13, wherein the at least one barrier sleeve insert is configured to restrict movement of at least one powder disposed within the mold cavity.

Embodiment 15: The mold assembly of any of Embodiments 11 through 14, wherein the at least one barrier sleeve insert is configured with communication holes that allow the body powder to flow through the at least one barrier sleeve insert.

Embodiment 16: The mold assembly of any of Embodiments 11 through 15, wherein at least two different powders are disposed into gaps created by the at least two stacked barrier sleeve inserts.

Embodiment 17: The mold assembly of any of Embodiments 11 through 16, wherein a material comprising the mold is chosen from a group of materials, the group comprising: graphite, ceramic, sand, clay, silicon, and tufa.

Embodiment 18: A mold assembly for manufacturing an earth boring tool, the mold comprising a mold cavity defining an interior surface in the mold and at least one containment sleeve insert disposed adjacent and spaced from the interior surface of the mold cavity.

Embodiment 19: The mold assembly of Embodiment 18, wherein the containment sleeve insert comprises a polymer material.

Embodiment 20: The mold assembly of any of Embodiments 18 and 19, wherein the polymer material is formulated to become a liquid or a gas at or below infiltration temperatures.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A method of manufacturing an earth boring tool including a tool body and blades extending radially from the tool body comprising:
providing a mold, the mold comprising a mold cavity defining an interior surface corresponding to an exterior shape of the tool body and the blades;
forming at least one barrier sleeve insert;
securing the at least one barrier sleeve insert adjacent and spaced away from the interior surface in the mold cavity;
disposing a first powder in a gap between the at least one barrier sleeve insert and the interior surface in the mold cavity;
disposing a second powder in the mold cavity;
disposing an infiltrant material adjacent the first powder and the second powder; and
heating the mold to melt and infiltrate the infiltrant material into the first powder and the second powder and form the tool body and the blades.

2. The method of claim 1, further comprising, forming the at least one barrier sleeve insert using an additive manufacturing process.

3. The method of claim 2, further comprising, forming the at least one barrier sleeve insert using a three-dimensional (3D) printer.

4. The method of claim 1, further comprising, forming the at least one barrier sleeve insert out of one or more materials including polymer, paper, resin, ceramic, composite, and metal or metal alloy.

5. The method of claim 4, further comprising, forming the at least one barrier sleeve insert from a polymer material.

6. The method of claim 5, wherein the polymer material is formulated to become a liquid or a gas at or below infiltration temperatures.

7. The method of claim 4, further comprising, forming the at least one barrier sleeve insert from a carbide material.

8. The method of claim 7, further comprising, forming the at least one barrier sleeve insert using a powder bed process.

9. The method of claim 1, further comprising, forming communication holes in the at least one barrier sleeve insert.

10. The method of claim 1, further comprising, disposing at least two barrier sleeve inserts on top of each other in the mold cavity.

11. The method of claim 10, further comprising disposing at least a third powder in the gap or gaps created by disposing the at least two barrier sleeve inserts on top of each other, thereby creating a transition region between the first powder and the second powder.

12. A mold assembly for manufacturing an earth boring tool, the mold assembly comprising:
a mold cavity defining an interior surface in the mold assembly; and
at least one barrier sleeve insert disposed adjacent and spaced from the interior surface of the mold cavity.

13. The mold assembly of claim 12, wherein the at least one barrier sleeve insert is configured to optimize placement of at least one powder placed within the mold cavity.

14. The mold assembly of claim 12, wherein the at least one barrier sleeve insert is configured to restrict movement of at least one powder disposed within the mold cavity.

15. The mold assembly of claim 13, wherein the at least one barrier sleeve insert is configured with communication holes that allow the at least one powder to flow through the at least one barrier sleeve insert.

16. The mold assembly of claim 15, wherein at least two different powders are disposed into gaps created by at least two stacked barrier sleeve inserts.

17. The mold assembly of claim 12, wherein a material comprising the mold assembly is chosen from a group of materials, the group of materials comprising: graphite, ceramic, sand, clay, silicon, and tufa.

18. A mold assembly for manufacturing an earth boring tool, the mold assembly comprising:
a mold cavity defining an interior surface in the mold assembly; and
at least one containment sleeve insert disposed adjacent and spaced from the interior surface of the mold cavity.

19. The mold assembly of claim 18, wherein the containment sleeve insert comprises a polymer material.

20. The mold assembly of claim 19, wherein the polymer material is formulated to become a liquid or a gas at or below infiltration temperatures.
